(19) United States
(12) Patent Application Publication
(10) Pub. No.: US 2025/0317529 A1
(43) Pub. Date: Oct. 9, 2025

(54) IMAGE RECORDING SYSTEM

(71) Applicant: JVCKENWOOD Corporation, Yokohama-shi (JP)

(72) Inventor: Takashi ONODERA, Yokohama-shi, Kanagawa (JP)

(21) Appl. No.: 19/243,778

(22) Filed: Jun. 20, 2025

Related U.S. Application Data
(63) Continuation of application No. PCT/JP2023/022557, filed on Jun. 19, 2023.

(30) Foreign Application Priority Data
Dec. 26, 2022 (JP) 2022-208474
Dec. 26, 2022 (JP) 2022-208475

(51) Int. Cl. H04N 5/91; G06V 10/74; G06V 20/40; G06V 20/58; H04N 7/18

(52) U.S. Cl. CPC H04N 5/91; G06V 10/761; G06V 20/44; G06V 20/58; H04N 7/183

(57) ABSTRACT

A server transmits a predetermined event condition to a drive recorder. When it is detected that a situation related to a vehicle fulfills an event condition, the drive recorder acquires an image of a recorded event capturing the situation related to the vehicle. The drive recorder acquires a continuously recorded image capturing the situation related to the vehicle continuously regardless of whether the situation related to the vehicle fulfills the event condition. The server generates a new event condition different from the predetermined event condition based on a result of analyzing the continuously recorded image transmitted from the drive recorder.

### BACKGROUND

### 1. Field

The present disclosure relates to an image recording system.

### 2. Description of the Related Art

Patent Literature 1 describes a technology of changing various setting values of a drive recorder from an external apparatus via a network, wherein the drive recorded is provided with a continuous recording function (also referred to as a continuous video recording function) and a trigger recording function (also referred to as an event recording function).
[Patent Literature 1] JP2014-032612

### SUMMARY

Until now, an event condition detected by the drive recorder as a trigger for imaging has been predetermined in the drive recorder or the external apparatus. We have considered that it is desirable to be able to set an event condition detected by the drive recorder in a flexible manner according to the driving condition of the vehicle, the driver's condition, etc.

The present disclosure results based on our awareness of the above-described issue, and a purpose thereof is to provide a technology of suitably setting an event condition detected by the drive recorder.

An image recording system according to an embodiment of the present disclosure includes: a drive recorder mounted on a vehicle; and a server. The server includes an event condition transmission unit that transmits a predetermined event condition to the drive recorder. The drive recorder includes: an event recording unit that acquires, when it is detected that a situation related to the vehicle or a driver fulfills the event condition, an image of a recorded event capturing the situation related to the vehicle or the driver; a continuous recording unit that acquires a continuously recorded image capturing the situation related to the vehicle or the driver continuously regardless of whether the situation related to the vehicle or the driver fulfills the event condition; and an image transmission unit that transmits at least the continuously recorded image to the server. The server further includes an event condition generation unit that generates a new event condition different from the predetermined event condition based on a result of analyzing the continuously recorded image transmitted from the drive recorder. The event condition transmission unit of the server transmits the new event condition to the drive recorder.

Optional combinations of the aforementioned constituting elements, and implementations of the embodiment in the form of apparatuses, methods, computer programs, and recording mediums recording computer programs are also useful as additional modes of the present disclosure.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows a configuration of an image recording system of the first embodiment;

FIG. 2 is a block diagram showing the functional blocks of the server of the first embodiment;

FIG. 3 is a flowchart showing the operation of the image recording system;

FIG. 4 schematically shows the process of generating meta information related to a dangerous driving situation;

FIG. 5 shows an example of the feature quantity map;

FIG. 6 shows an example of the standardized feature map;

FIG. 7 shows an example of the parameter adjustment table;

FIG. 8 shows the relationship between compared data and corresponding cluster;

FIG. 9 is a block diagram showing the functional blocks of the drive recorder of the variation;

FIG. 10 is a block diagram showing the functional blocks of the server of the second embodiment;

FIG. 11 schematically shows the process of generating meta information related to a safe driving situation;

FIG. 12 shows an example of determination of a feature parameter; and

FIG. 13 shows an example of the parameter adjustment table.

### DETAILED DESCRIPTION

The invention will now be described by reference to the preferred embodiments. This does not intend to limit the scope of the present invention, but to exemplify the invention.

### First Embodiment

The image recording system of the first embodiment autonomously adds a new event that triggers the start of event recording based on the result of analysis of a video captured by the continuous recording function of the drive recorder of a vehicle. The image recording system of the first embodiment adds, when it is determined that the situation related to vehicle driving, the driver's condition, etc. is similar to a dangerous driving situation, a new event based on the dangerous driving situation.

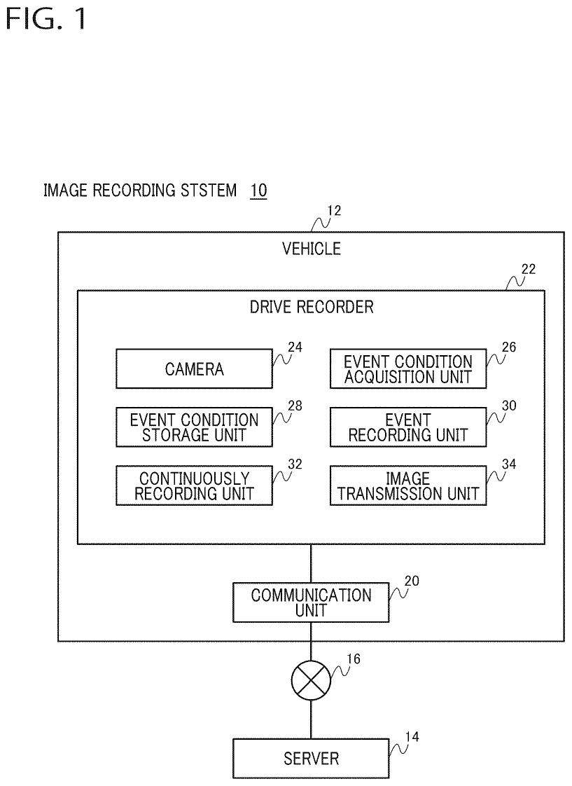

FIG. 1 shows a configuration of an image recording system 10 of the first embodiment. The image recording system 10 is an information processing system including a drive recorder 22 mounted on a vehicle 12 and a server 14. The vehicle 12 includes a communication unit 20 and a drive recorder 22. The communication unit 20 communicates with an external apparatus according to a predetermined communication protocol and, in the first embodiment, is connected to the server 14 via a communication network 16 including LAN, WAN, and the Internet. The drive recorder 22 transmits and receives data to and from the server 14 via the communication unit 20.

FIG. 1 includes a block diagram showing the functional blocks of the drive recorder 22. The drive recorder 22 includes a camera 24, an event condition acquisition unit 26, an event condition storage unit 28, an event recording unit 30, a continuous recording unit 32, and an image transmission unit 34. The blocks depicted in the block diagrams of this specification are implemented in hardware by devices/electronic circuits/mechanical apparatuses exemplified by a processor, a CPU, and a memory of a computer, and in software by a computer program, etc. FIG. 1 depicts functional blocks implemented by the cooperation of these elements. Therefore, it will be understood by those skilled in the art that these functional blocks may be implemented in a variety of manners by a combination of hardware and software.

The camera 24 is an imaging apparatus for imaging the surroundings of the vehicle 12 and the vehicle interior. The subject of imaging in the vehicle interior may be the driver (in particular, the face of the driver). In a variation, the subject imaged by the camera 24 may be either one of the surroundings of the vehicle 12 or the vehicle interior.

The event condition acquisition unit 26 acquires an event condition transmitted from the server 14. The event condition storage unit 28 stores one or more event conditions acquired by the event condition acquisition unit 26.

An event condition is data for determining a condition for fulfillment of an event that triggers the start of event recording in the drive recorder 22 and, in other words, is data for determining a condition to start event recording. The event condition includes a condition related to the driving condition of the vehicle 12. For example, the event condition may be that the speed of the vehicle 12 reaches a specific value, or the distance between the vehicle 12 and a further vehicle reaches a specific value. Further, the event condition includes a condition related to the condition of the driver of the vehicle 12. For example, the event condition may be that the rate of change in the area of the driver's face imaged reaches a specific value or that the driver's continuous eye closure time reaches a specific value.

Based on an image captured by a sensor (not shown) and the camera 24 mounted on the vehicle 12, the event recording unit 30 determines whether the situation related to the vehicle 12 (including the condition of the driver of the vehicle 12; the same applies hereinafter) fulfills the event condition stored in the event condition storage unit 28. A publicly known technology may be used for determination as to whether the event condition is fulfilled. When the event recording unit 30 detects that the situation related to the vehicle 12 fulfills the event condition, the event recording unit 30 acquires a video of a recorded event (hereinafter also referred to as a “recorded event video”) capturing the situation related to the vehicle 12. When the event recording unit 30 detects that at least one of a plurality of event conditions has been fulfilled, the event recording unit 30 may acquire, as the recorded event video, the video captured by the camera 24 during a predetermined period before and after (e.g., 30 seconds before and after) the point of time of detection.

Regardless of whether the situation related to the vehicle 12 fulfills the event condition, the continuous recording unit 32 acquires a continuously recorded video capturing the situation related to the vehicle 12 continuously (hereinafter also referred to as “continuously recorded video”) at a predetermined cycle. The camera 24 may continuously image the surroundings of the vehicle 12 and vehicle interior, and the continuously recorded video may be data for one-minute portion of the video continuously capturing the surroundings of the vehicle 12 and vehicle interior. The image transmission unit 34 transmits to the server 14 the data for the recorded event video acquired by the event recording unit 30 and the data for the constantly recorded video acquired by the continuous recording unit 32.

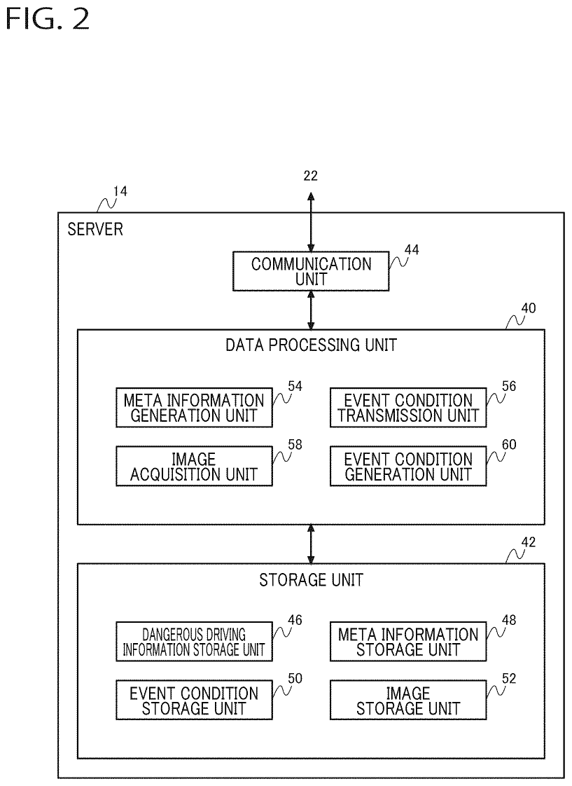

FIG. 2 is a block diagram showing the functional blocks of the server 14 of the first embodiment. The server 14 includes a data processing unit 40, a storage unit 42, and a communication unit 44. The data processing unit 40 executes various data processes. The storage unit 42 stores data referenced or updated by the data processing unit 40. The communication unit 44 communicates with the external apparatus according to a predetermined communication protocol. The data processing unit 40 transmits and receives data to and from the drive recorder 22 via the communication unit 44.

The storage unit 42 includes a dangerous driving information storage unit 46, a meta information storage unit 48, an event condition storage unit 50, and an image storage unit 52. The dangerous driving information storage unit 46 stores data for a video showing a dangerous driving situation (hereinafter also referred to as a “dangerous driving video”). The dangerous driving video may be, for example, a video capturing a driving situation considered to have a high risk of an accident. Further, the dangerous driving information storage unit 46 also stores data (hereinafter also referred to as “dangerous driving situation data”) indicating the driving situation (e.g., the speed of the vehicle 12, the steering angle, etc.) at the point of time when the dangerous driving video is taken. The dangerous driving information storage unit 46 stores a plurality of dangerous driving videos and a plurality of pieces of dangerous driving situation data corresponding to the respective dangerous driving videos. The data for the dangerous driving video and the dangerous driving situation data stored in the dangerous driving information storage unit 46 may be predetermined by the administrator of the server 14, etc. Further, the data for the dangerous driving video and the dangerous driving situation data stored in the dangerous driving information storage unit 46 may include data registered from the drive recorder 22. For example, it may include data for the recorded event video recorded by the drive recorder 22 based on the event condition before a change and data indicating the driving situation acquired by the drive recorder 22 when the event condition before the change is fulfilled.

The meta information storage unit 48 stores meta information related to the dangerous driving situation, including the feature quantity extracted from the dangerous driving video and the dangerous driving situation data. Specific examples of meta information will be described later.

The event condition storage unit 50 stores a predetermined event condition. The event condition stored in the event condition storage unit 50 may include an event condition defined by the administrator of the image recording system 10 or the user of the recorded event video recorded by the image recording system 10. Further, the event condition storage unit 50 stores the new event condition generated by the event condition generation unit 60 described later. The image storage unit 52 stores data for the recorded event video transmitted from the drive recorder 22.

The data processing unit 40 includes a meta information generation unit 54, an event condition transmission unit 56, an image acquisition unit 58, and an event condition generation unit 60. The functions of at least some of these plurality of functional blocks may be implemented in a computer program. The computer program may be installed in the storage of the server 14 via a recording medium or a communication network. The processor (CPU, etc.) of the server 14 may exhibit the function of the function block implemented in the computer program by reading the computer program into the main memory and executing the program.

The meta information generation unit 54 extracts a feature quantity from the dangerous driving video and the dangerous driving situation data stored in the dangerous driving information storage unit 46 and generates meta information related to the dangerous driving situation. The meta information generation unit 54 stores the meta information thus generated in the meta information storage unit 48. Details of the process in the meta information generation unit 54 will be described later.

The event condition transmission unit 56 transmits the predetermined event condition stored in the event condition storage unit 50 to the drive recorder 22. The event condition transmission unit 56 also transmits the new event condition generated by the event condition generation unit 60 to the drive recorder 22.

The image acquisition unit 58 acquires the data for the recorded event video and the data for the continuously recorded video transmitted from the drive recorder 22. The image acquisition unit 58 stores the data for the recorded event video thus acquired in the image storage unit 52.

The event condition generation unit 60 generates a new event condition different from the predetermined event condition based on the result of analyzing the data for the continuously recorded video transmitted from the drive recorder 22 and acquired by the image acquisition unit 58. The event condition generation unit 60 generates the new event condition based on the feature of an image showing a dangerous driving situation and the driving situation (the dangerous driving video described above) having a high degree of similarity to the feature of the continuously recorded video. The event condition generation unit 60 sets the new event condition such that the higher the similarity between the feature of the continuously recorded video and the feature of the image showing a dangerous driving situation and the driving situation (the dangerous driving video described above), the easier the event condition is fulfilled.

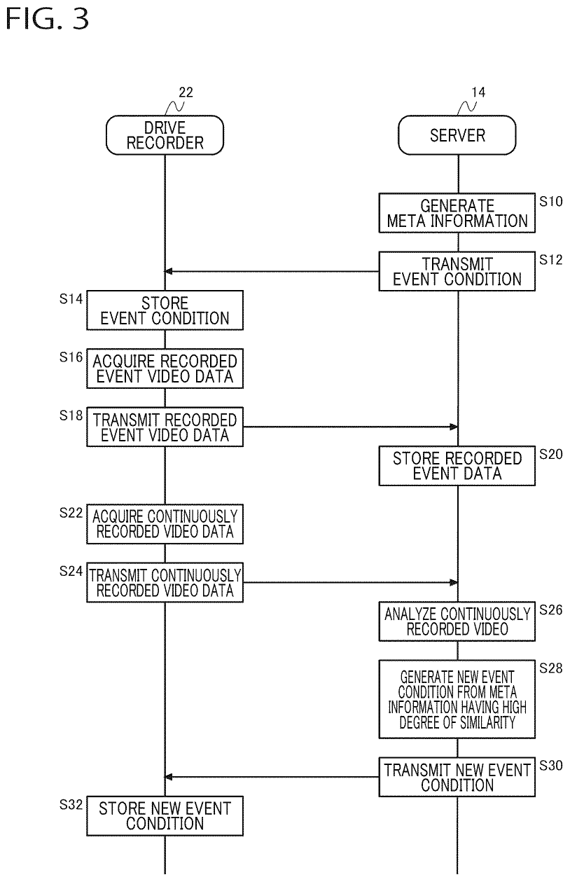

The operation of the image recording system 10 according to the above configuration will be described. FIG. 3 is a flowchart showing the operation of the image recording system 10. The meta information generation unit 54 of the server 14 generates meta information related to the dangerous driving situation based on the dangerous driving video and the dangerous driving situation data stored in the dangerous driving information storage unit 46 (step S10).

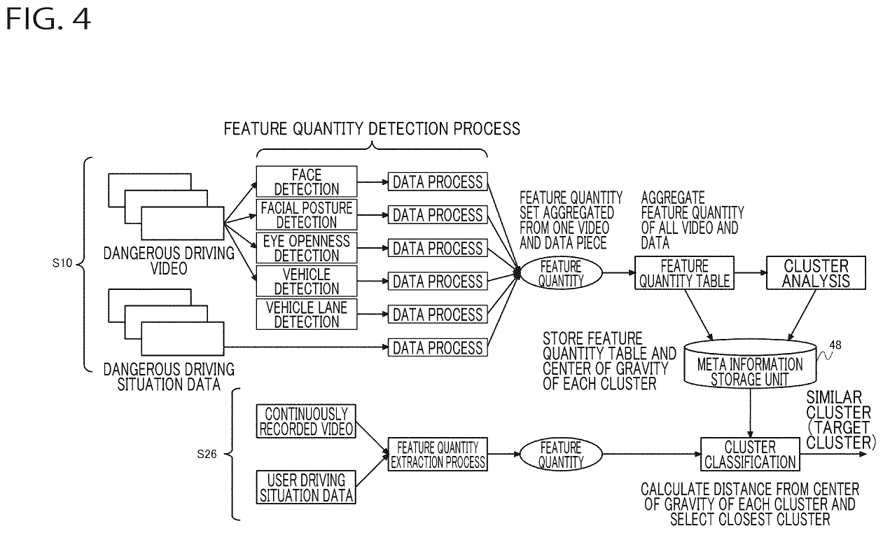

FIG. 4 schematically shows the process of generating meta information related to a dangerous driving situation, i.e., schematically shows the process of step S10 of FIG. 3. The meta information generation unit 54 extracts the feature quantity of the dangerous driving video and the dangerous driving situation data by using an image recognition model that is a mathematical model generated by machine learning. For example, the meta information generation unit 54 may extract a feature quantity related to a change in the face area captured in the dangerous driving video, a feature quantity related to a change in the posture of the face (a change in the yaw angle of the face, etc.), and a feature quantity related to the continuous eye closure time. A publicly known technology may be used for extraction of the feature quantity.

In the first embodiment, the meta information generation unit 54 performs cluster analysis to classify the feature quantity of a plurality of dangerous driving videos into a plurality of clusters. A publicly known method may be used for cluster analysis, and the analysis method is not particularly limited. It is necessary to group a plurality of dangerous driving videos such that the same type of dangerous driving is grouped into the same class. In this case, cluster analysis is performed to classify the feature quantity of the plurality of dangerous driving videos into a plurality of clusters. The meta information generation unit 54 derives the center of gravity of each cluster and uses a value derived from standardizing the feature quantity of the center of gravity of each cluster as a feature parameter characterizing the cluster. In one variation, the meta information generation unit 54 may perform principal component analysis to extract a feature parameter of each cluster based on the eigenvector of the component having a high contribution ratio.

Specifically, the meta information generation unit 54 determines the feature quantity of the center of each of the plurality of clusters and stores, as the meta information, a feature quantity map indicating the feature quantity of the center of gravity of each cluster in the meta information storage unit 48. Further, the meta information generation unit 54 further stores, as the meta information, a standardized feature quantity map derived from standardizing the feature quantity map feature by feature in the meta information storage unit 48. Standardization is, for example, converting the average of the values of the features into 0 and the variance into 1.

$$Y = {P}_{g} \pm 2 {P}_{o} \times \frac{1}{exp ( \frac{d}{max\_d} )} \qquad ( expression 1 )$$

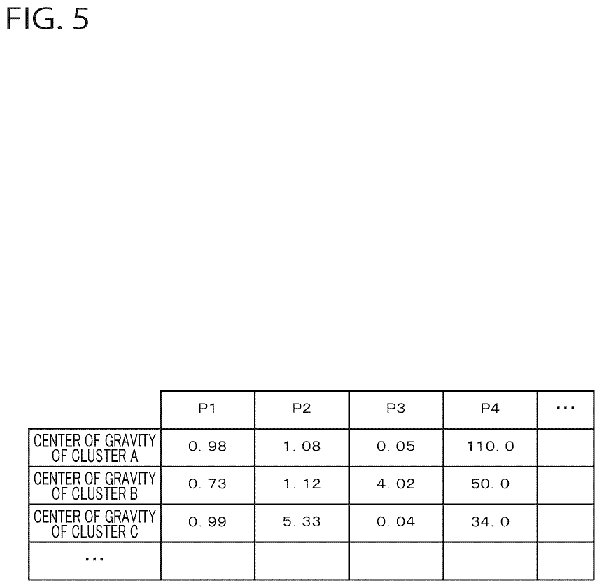

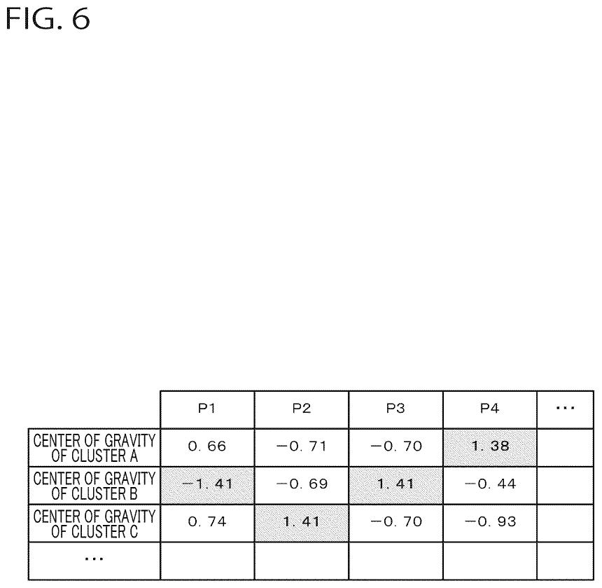

FIG. 5 shows an example of the feature quantity map. The feature quantity map of FIG. 5 is data that maps the feature quantity of features P1-P5 to the center of gravity of each of cluster A-cluster C. For example, feature P1 is the amount of change in the face area, feature P2 is the amount of change in the face yaw angle, and feature P3 is the continuous eye closing time. FIG. 6 shows an example of the standardized feature map. The meta information generation unit 54 determines the feature with a standardized value of 1 or more as the feature parameter of each cluster. In FIG. 6, the feature parameter of each cluster is shown in shades.

Returning to FIG. 3, the event condition transmission unit 56 of the server 14 transmits the event condition stored in advance in the event condition storage unit 50 to the drive recorder 22 (step S12). The event condition acquisition unit 26 of the drive recorder 22 accepts the event condition transmitted from the server 14 and stores the received event condition in the event condition storage unit 28 (step S14).

When the event recording unit 30 of the drive recorder 22 detects that the situation related to the vehicle 12 or the driver fulfills the event condition, the event recording unit 30 acquires a recorded event video based on the video captured by the camera 24 (step S16). The image transmission unit 34 of the drive recorder 22 transmits the data for the recorded event video to the server 14 (step S18). The image acquisition unit 58 of the server 14 receives the data for the recorded event video transmitted from the drive recorder 22 and stores the data in the image storage unit 52 (step S20).

The continuous recording unit 32 of the drive recorder 22 periodically acquires, as the continuously recorded video, the video captured by the camera 24 regardless of whether the situation related to the vehicle 12 and the driver fulfills the event condition (step S22). The image transmission unit 34 of the drive recorder 22 transmits the continuously recorded video to the server 14 (step S24).

The image transmission unit 34 acquires the driving situation of the vehicle 12 (e.g., the speed, the steering angle, etc. of the vehicle 12) from a sensor, a control apparatus, etc. (e.g., an ECU (Electronic Control Unit)) (not shown). In step S24, the image transmission unit 34 transmits data (hereinafter also referred to as “user driving situation data”) indicating the driving situation at the point of time when the video is taken (hereinafter, also referred to as “user driving situation data”) to the server 14 along with the continuously recorded video.

The image acquisition unit 58 of the server 14 receives the continuously recorded video and the user driving situation data transmitted from the drive recorder 22. The event condition generation unit 60 of the server 14 analyzes the continuously recorded video and the user driving situation data received by the image acquisition unit 58 and extracts feature quantity related to the user's current driving situation (step S26). The continuously recorded video and the user driving situation data are collectively referred to as “compared data”.

FIG. 4 includes content schematically showing the process in S26 of FIG. 3. The event condition generation unit 60 executes the same data process as in S10 and extracts the feature quantity of the continuously recorded video and the user driving situation data (hereinafter also referred to as “user feature quantity”). For example, the event condition generation unit 60 may extract, as the user feature quantity, a feature quantity related to a change in the face area, a feature quantity related to a change in the posture of the face, and a feature quantity related to the continuous eye closure time captured in the continuously recorded video.

Returning to FIG. 3, the event condition generation unit 60 generates a new event condition based on, of the plurality of pieces of meta information related to the plurality of dangerous driving videos stored in the meta information storage unit 48, the meta information having a high degree of similarity to the user feature quantity of the data compared (S28). The event condition generation unit 60 stores the new event condition thus generated in the event condition storage unit 50.

Specifically, the event condition generation unit 60 calculates the distance between the center of gravity of each cluster stored in the meta information storage unit 48 and the user feature quantity and selects the cluster (hereinafter also referred to as a “corresponding cluster”) for which the center of gravity is closest to the user feature quantity. Stated otherwise, the event condition generation unit 60 selects, as the corresponding cluster, the cluster having the highest degree of similarity to the user feature quantity.

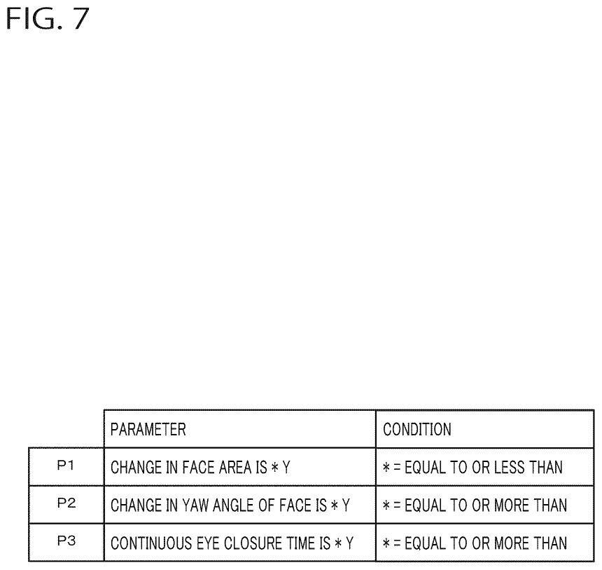

The storage unit 42 of the server 14 stores a parameter adjustment table predefined for each feature quantity. FIG. 7 shows an example of the parameter adjustment table. The parameter adjustment table is data that maps the parameter (including the threshold value Y) of the event condition to a condition. The condition is automatically determined based on the polarity of standardization of each cluster.

When the corresponding cluster of the compared data is cluster C, for example, the feature parameter of cluster C is P2 as shown in FIG. 6, and so the event condition generation unit 60 selects the condition in table P2. When the corresponding cluster of the compared data is cluster B, on the other hand, the feature parameters of cluster B are P1 and P3, and so the event condition generation unit 60 selects the condition in table P1 and the condition in table P3 as conditions to be ANDed.

The event condition generation unit 60 derives, as the new event condition, a threshold value Y (parameter) according to expression 1.

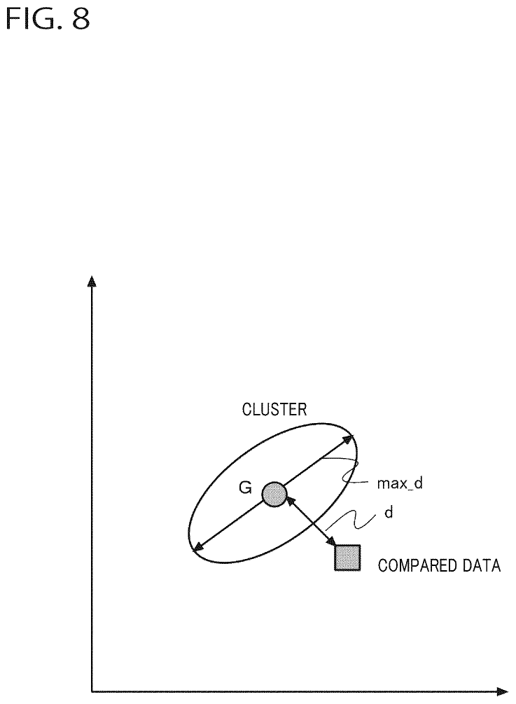

Each term of expression 1 will be explained with reference to FIG. 8, which shows the relationship between the compared data and the corresponding cluster. Pg denotes the feature quantity of the center of gravity G of the corresponding cluster and, specifically, is the value of the feature parameter of the center of gravity G of the corresponding cluster. Pσ denotes the standard deviation of the feature of the corresponding cluster. d denotes the distance from the compared data to the center of gravity G of the corresponding cluster. max_d denotes the maximum distance of the corresponding cluster. ± in expression 1 will be negative when the polarity of the standardization is positive and positive when the polarity is negative. Since the only variable is the distance d, the item values other than the distance d of each cluster may be stored in the storage unit 42 in advance.

The event condition generation unit 60 generates a new event condition that includes the threshold value Y determined by the similarity between i) the feature of the image showing the dangerous driving situation, i.e., the feature of the corresponding class and ii) the feature of the continuously recorded video, i.e., the feature of the compared data. Specifically, as shown in expression 1, the smaller the distance d from the compared data to the center of gravity G of the corresponding cluster, i.e., the higher the degree of similarity between the feature of the continuously recorded video and the feature of the dangerous driving video, the more distanced the threshold value Y is from the center of gravity G of the cluster. The distance of the threshold Y from the center of gravity G of the corresponding cluster makes it easy for the new event condition to be fulfilled. By deriving the threshold Y for the new event condition based on expression 1, the frequency that an event is recorded when the user's driving situation is similar to a dangerous driving situation can be increased, and it becomes easier to collect recorded event videos showing dangerous driving situations.

Given that the corresponding cluster of the compared data is cluster C, the threshold value Y of the feature parameter P2 is calculated, for example, as follows.

Y=5.33−2×0.71×1/exp(0.68/1.76)=4.26

“5.33” is the value of P2 of the center of gravity of cluster C shown in FIG. 5. “0.71” is the standard deviation of the feature of cluster C derived by calculation. “0.68” is the distance from the compared data to the center of gravity of cluster C derived by calculation. “1.76” is the maximum distance of cluster C derived by calculation. As shown in FIG. 7, the threshold value Y of P2 is the threshold value of the change in the face yaw angle. The event condition generation unit 60 may generate “the change in the face yaw angle of 4.26 degrees or more” as a new event condition according to the compared data.

The event condition transmission unit 56 of the server 14 transmits the new event condition generated by the event condition generation unit 60 to the drive recorder 22 (step S30). The event condition acquisition unit 26 of the drive recorder 22 acquires the new event condition and stores it in the event condition storage unit 28 (step S32). Thereafter, the event recording unit 30 of the drive recorder 22 acquires a recorded event video based on the new event condition in addition to the previous event condition.

According to the image recording system 10 of the first embodiment, the condition to start event recording in the drive recorder 22 can be set dynamically and flexibly according to the degree of similarity between the continuously recorded video recorded by the drive recorder 22 and the video capturing a dangerous driving situation prepared in advance. This makes it easier to collect recorded event videos that capture dangerous driving situations.

A variation of the first embodiment will be described. The drive recorder 22 of the variation includes the function provided in the server 14 in the first embodiment. Specifically, the drive recorder 22 of the variation analyzes the continuously recorded video and autonomously adds a new event condition that triggers the start of event recording based on the analysis result.

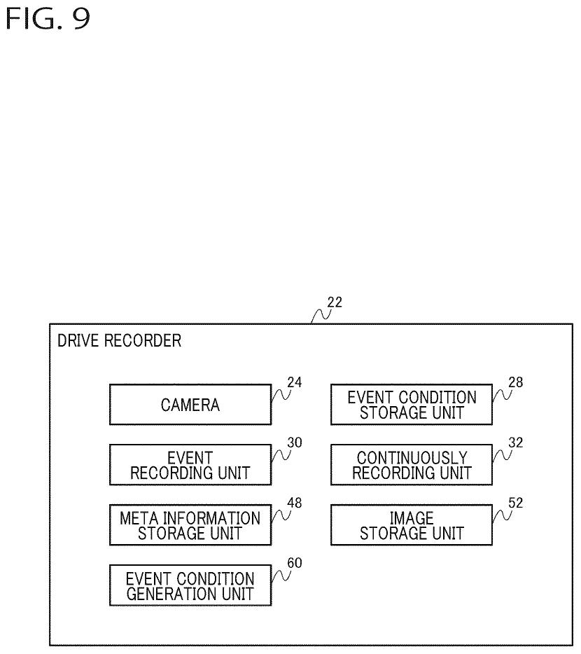

FIG. 9 is a block diagram showing the functional blocks of the drive recorder 22 of the variation. In addition to the functional blocks of the drive recorder 22 of the first embodiment shown in FIG. 1, the drive recorder 22 of the variation includes a meta information storage unit 48, an image storage unit 52, and an event condition generation unit 60.

The meta information storage unit 48 stores meta information related to the dangerous driving situation that includes the feature quantity extracted from the dangerous driving video and the dangerous driving situation data. The meta information stored in the meta information storage unit 48 may be predetermined information or may be information downloaded from an external apparatus such as the server 14.

The image storage unit 52 stores the recorded event video acquired by the event recording unit 30. The event condition generation unit 60 generates a new event condition different from the predetermined event condition stored in the event condition storage unit 28, based on the meta information related to the dangerous driving situation stored in the meta information storage unit 48 and the result of analyzing the continuously recorded video acquired by the continuous recording unit 32.

The drive recorder 22 of the variation provides the same benefit as the image recording system 10 of the first embodiment. In other words, the drive recorder 22 capable of dynamically and flexibly setting an event condition detected as a trigger for event recording can be realized according to the variation.

The drive recorder 22 of the variation may further include the dangerous driving information storage unit 46 and the meta information generation unit 54 provided in the server 14 of the first embodiment. In other words, the drive recorder 22 of the variation may further execute a process of extracting a feature quantity from the dangerous driving video and the dangerous driving situation data and generating meta information related to the dangerous driving situation based on the feature quantity.

### Second Embodiment

The following description of the second embodiment highlights the difference from the first embodiment, and a description of common features is omitted. The feature of the second embodiment can be combined with the feature of the first embodiment and the variation as desired. Of the components of the second embodiment, those components that are the same as or correspond to the components of the first embodiment will be described by denoting them with the same reference numerals as appropriate.

Like the image recording system of the first embodiment, the image recording system of the second embodiment autonomously adds a new event that triggers the start of event recording based on the result of analyzing the video captured by the continuous recording function of the drive recorder of the vehicle. The image recording system of the second embodiment differs from the image recording system of the first embodiment in that, when it is determined that the status related to the driving of the vehicle, the driver's condition, etc. are greatly different from the safe driving situation, the image recording system of the second embodiment adds a new event based on the safe driving situation.

The configuration of the image recording system 10 of the second embodiment is the same as the configuration of the image recording system 10 of the first embodiment shown in FIG. 1. Further, the functional block included in the drive recorder 22 of the second embodiment is the same as the functional block provided in the drive recorder 22 of the first embodiment shown in FIG. 1.

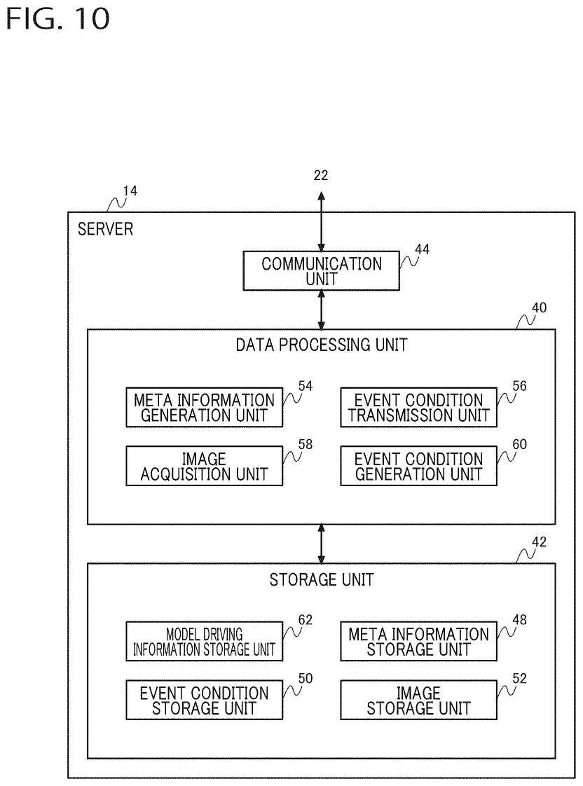

FIG. 10 is a block diagram showing the functional blocks of the server 14 of the second embodiment. The server 14 of the second embodiment differs from the server 14 of the first embodiment in that it includes a model driving information storage unit 62 instead of the dangerous driving information storage unit 46. Further, in the server 14 of the second embodiment, the process in the meta information generation unit 54 and the event condition generation unit 60 is different from that of the server 14 of the first embodiment. The difference from the first embodiment will be described.

The model driving information storage unit 62 stores data for a video showing a safe driving situation, i.e., a video showing a model driving situation (hereinafter also referred to as a “model driving video”). Further, the model driving information storage unit 62 further stores data (hereinafter also referred to as “model driving situation data”) indicating the driving situation (e.g., the speed of the vehicle 12, the steering angle, etc.) at the point of time when the model driving video is taken. The model driving information storage unit 62 stores a plurality of model driving videos and a plurality of pieces of model driving situation data corresponding to each model driving video.

The meta information generation unit 54 extracts the feature quantity from the model driving video and the model driving situation data stored in the model driving information storage unit 62, generates meta information related to a safe driving situation (in other words, a model driving situation), and stores the meta information thus generated in the meta information storage unit 48.

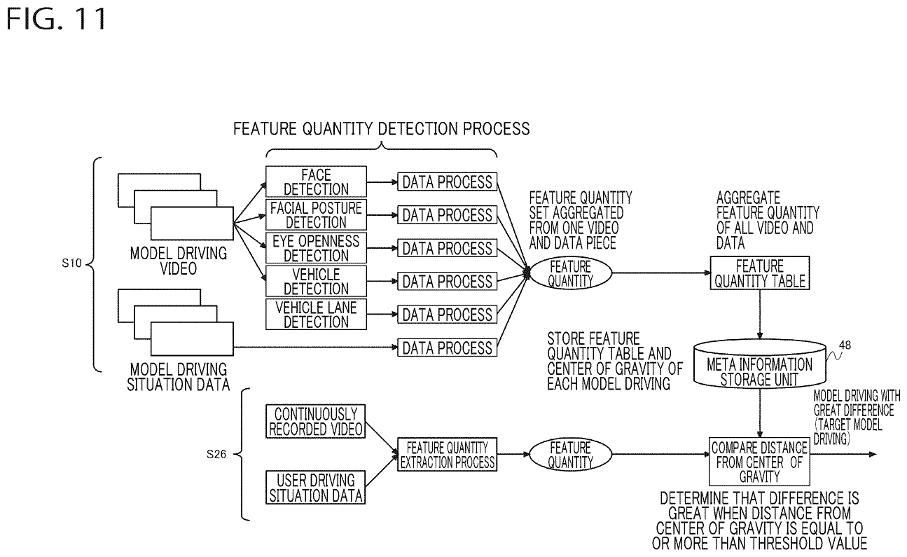

FIG. 11 schematically shows the process of generating meta information related to a safe driving situation. The meta information generation unit 54 extracts the feature quantity of the model driving video and the model driving situation data by using an image recognition model generated by machine learning. The items of the feature may be the same as those of the first embodiment. The meta information generation unit 54 stores, as the meta information, a feature quantity table grouping the feature quantity of a plurality of items respectively related to a plurality of model driving videos and the center of gravity of the feature quantity of a plurality of items of each model driving video in the meta information storage unit 48.

The event condition generation unit 60 generates a new event condition based on the feature of an image (i.e., a model driving video) showing a safe driving situation greatly different from the feature of the continuously recorded video transmitted from the drive recorder 22. The event condition generation unit 60 sets the new event condition such that the larger the difference between the feature of the continuously recorded video and the feature of the model driving video, the easier the event condition is fulfilled.

FIG. 11 includes content schematically showing the process on the continuously recorded video and the user driving situation data (i.e., the compared data). As in the first embodiment, the event condition generation unit 60 extracts the feature quantity (i.e., the user feature quantity) of the continuously recorded video and the user driving situation data. Among the plurality of pieces of meta information related to the plurality of model driving videos stored in the meta information storage unit 48, the event condition generation unit 60 generates a new event condition based on the meta information greatly different from the user feature quantity of the compared data.

Specifically, the event condition generation unit 60 calculates the distance between the center of gravity of each model driving feature quantity stored in the meta information storage unit 48 and the user feature quantity and selects the model driving for which the distance exceeds a predetermined threshold value (hereinafter also referred to as “target model driving”). In other words, the event condition generation unit 60 selects a model driving having a relatively large difference from the user feature as the target model driving. This threshold value may be determined appropriately based on the knowledge of the developer of the image recording system 10 and an experiment using the image recording system 10.

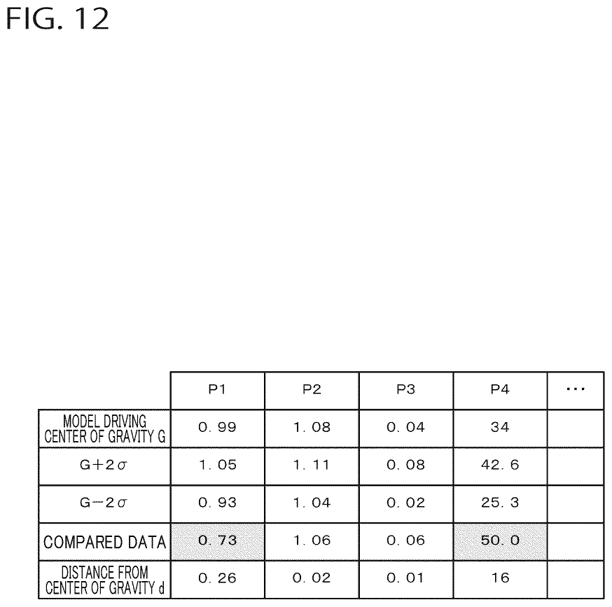

FIG. 12 shows an example of determination of a feature parameter. FIG. 12 shows the feature quantity of the plurality items P1-P4 of the center of gravity G of the target model driving and the feature quantity of the plurality items P1-P4 of the compared data. The event condition generation unit 60 compares the feature quantity of the target model driving stored in the meta information storage unit 48 with the feature quantity of the compared data. Of the items of the compared data, the event condition generation unit 60 determines, as the feature parameter, the item of the compared data that differs by +20 (o is a standard deviation) or more from the feature quantity of the target model driving. In the example of FIG. 12, feature P1 (e.g., the amount of change in the face area) and feature P4 (e.g., the speed of the vehicle 12) are determined to be feature parameters.

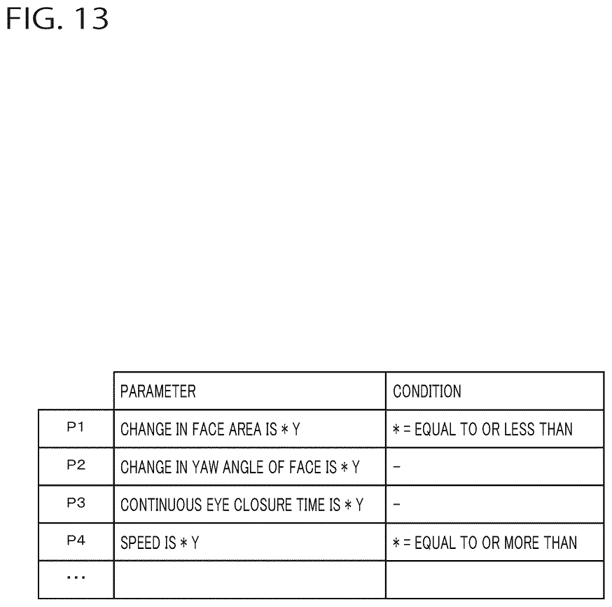

In the second embodiment, too, the storage unit 42 of the server 14 stores a parameter adjustment table predetermined for each feature quantity. FIG. 13 shows an example of the parameter adjustment table. The condition is determined according to whether the value of the compared data is lower or higher than the value of the center of gravity.

If the comparison data is-20 or less from the center of gravity, the event condition generation unit 60 derives a threshold value Y according to expression 2.

Y=G−d/2 (expression 2)

If the comparison data is +20 or more from the center of gravity, the event condition generation unit 60 derives the threshold value Y according to expression 3.

Y=G+d/2 (expression 3)

G in expression 2 and expression 3 denotes the value of the feature parameter of the center of gravity of the target model driving. d denotes the distance from the center of gravity of the target model driving to the value of the compared data. When the feature parameter is P4 and the compared data is distanced by +20 or more from the center of gravity, the event condition generation unit 60 may derive the threshold value Y related to the speed of the vehicle 12 as 42 (=34+16/2). In this case, the event condition generation unit 60 may generate a new event condition that requires “the vehicle speed of 42 or more”.

The event condition generation unit 60 generates a new event condition that includes the threshold value Y determined by the difference between i) the feature of the image showing a safe driving situation, i.e., the feature of the corresponding model driving and ii) the feature of the continuously recorded video, i.e., the feature of the compared data. Specifically, as shown in expressions 2 and 3, the greater the distance d from the comparative data to the center of gravity of the corresponding model driving, in other words, the greater the difference between the feature of the continuously recorded video and the feature of the model driving video, the more distanced the threshold value Y is from the center of gravity G of the corresponding model driving. The distance of the threshold Y from the center of gravity G of the corresponding cluster makes it easy for the new event condition to be fulfilled. By deriving the threshold Y for the new event condition based on expression 2 and expression 3, the frequency that an event is recorded when the user's driving situation differs greatly from the safe driving situation (i.e., the model driving situation) can be increased, and it is easy to collect recorded event videos showing dangerous driving situations.

According to the image recording system 10 of the second embodiment, the condition to start event recording in the drive recorder 22 can be set dynamically and flexibly according to the difference between the continuously recorded video recorded by the drive recorder 22 and the video showing a safe driving situation prepared in advance. Like the image recording system 10 of the first embodiment, the image recording system 10 of the second embodiment makes it easier to collect event recordings that capture dangerous driving situations.

A variation relating to the second embodiment will be described. The drive recorder 22 of the variation has the function that is provided in the server 14 in the second embodiment. Specifically, the drive recorder 22 of the variation analyzes the continuously recorded video and autonomously adds, based on the analysis result, a new event condition that triggers the start of event recording.

The drive recorder 22 of the variation includes the functional blocks shown in the block diagram of FIG. 9. In other words, the drive recorder 22 of the variation includes the meta information storage unit 48, the image storage unit 52, and the event condition generation unit 60 in addition to the functional blocks of the drive recorder 22 of the second embodiment.

The meta information storage unit 48 stores meta information related to the safe driving situation, including the feature quantity extracted from the model driving video and the model driving situation data. The image storage unit 52 stores the recorded event video acquired by the event recording unit 30. The event condition generation unit 60 generates a new event condition different from the predetermined event condition stored in the event condition storage unit 28, based on the meta information related to the safe driving situation stored in the meta information storage unit 48 and the result of analyzing the continuously recorded video acquired by the continuous recording unit 32.

The drive recorder 22 of the variation provides the same benefit as the image recording system 10 of the second embodiment. In other words, the drive recorder 22 capable of dynamically and flexibly setting an event condition detected as a trigger for event recording can be realized according to the variation.

The drive recorder 22 of the variation may further include the model driving information storage unit 62 and the meta information generation unit 54 provided in the server 14 of the second embodiment. In other words, the drive recorder 22 of the variation may further execute a process of extracting the feature quantity from the model driving video and the model driving situation data and generating meta information related to the safe driving situation based on the feature quantity.

A variation related to both the first and second embodiments will be described. In the first and second embodiments, the image transmission unit 34 of the drive recorder 22 transmits both the recorded event video and the continuously recorded video to the server 14. In a variation, the image transmission unit 34 may transmit the recorded event video to an external apparatus (e.g., a dedicated apparatus for video collection) different from the server 14. Further, the drive recorder 22 may store the recorded event video in the storage unit of the drive recorder 22 without sending it to the external apparatus. In this case, the image transmission unit 34 of the drive recorder 22 may only transmit the continuously recorded video to the server 14.

Given above is a description of the present disclosure based on the first and second embodiments. The details described in the embodiments are intended to be illustrative only and it will be understood by those skilled in the art that various variations to combinations of constituting elements and processes of the embodiments are possible and that such variations are also within the scope of the present disclosure.

Any combination of the embodiment and the variation described above will also be useful as an embodiment of the present disclosure. New embodiments created by the combination provide the advantages of embodiment and the variation combined. It will also be understood by skilled persons that the functions that the constituting elements recited in the claims should achieve are implemented either alone or in combination by the constituting elements shown in the embodiment and the variations.

The following technologies are disclosed according to the above description of the embodiments and the variations.

### Technology 1

A drive recorder mounted on a vehicle, including:
an event recording unit that acquires, when it is detected that a situation related to the vehicle or a driver fulfills a predetermined event condition, an image of a recorded event capturing the situation related to the vehicle or the driver;
a continuous recording unit that acquires a continuously recorded image capturing the situation related to the vehicle or the driver continuously regardless of whether the situation related to the vehicle or the driver fulfills the event condition; and
an event condition generation unit that generates a new event condition different from the predetermined event condition based on a result of analyzing the continuously recorded image.

### Technology 2

The drive recorder according to Technology 1,
wherein the event condition generation unit generates the new event condition based on a feature of an image showing a dangerous driving situation having a high similarity to a feature of the continuously recorded image.

### Technology 3

The drive recorder according to Technology 1 or 2,
wherein the event condition generation unit generates the new event condition that includes a threshold value determined by a similarity between a feature of an image showing a dangerous driving situation and a feature of the continuously recorded image transmitted from the drive recorder.

### Technology 4

The drive recorder according to any one of Technologies 1 through 3,
wherein the event condition generation unit generates the new event condition based on a feature of an image showing a safe driving situation greatly different from a feature of the continuously recorded video.

### Technology 5

The drive recorder according to any one of Technologies 1 through 4,
wherein the event condition generation unit generates the new event condition that includes a threshold value determined by a difference between a feature of an image showing a safe driving situation and a feature of the continuously recorded image transmitted from the drive recorder.

### CROSS-REFERENCE TO RELATED APPLICATION

This application is based upon and claims the benefit of priority from the prior Japanese Patent Application No. 2022-208474, filed on Dec. 26, 2022, the prior Japanese Patent Application No. 2022-208475, filed on Dec. 26, 2022, and the prior PCT Application No. PCT/JP2023/022557, filed on Jun. 19, 2023, the entire contents of which are incorporated herein by reference.

What is claimed is:

1. An image recording system comprising:
a drive recorder mounted on a vehicle; and
a server,
wherein the server includes an event condition transmission unit that transmits a predetermined event condition to the drive recorder,
wherein the drive recorder includes:
an event recording unit that acquires, when it is detected that a situation related to the vehicle or a driver fulfills the event condition, an image of a recorded event capturing the situation related to the vehicle or the driver;
a continuous recording unit that acquires a continuously recorded image capturing the situation related to the vehicle or the driver continuously regardless of whether the situation related to the vehicle or the driver fulfills the event condition; and
an image transmission unit that transmits at least the continuously recorded image to the server,
wherein the server further includes an event condition generation unit that analyzes the continuously recorded image transmitted from the drive recorder and data indicating a driving situation at a point of time when the image is recorded and generates a new event condition different from the predetermined event condition based on a result of analysis and meta information related to a dangerous driving situation or a safe driving situation, and
wherein the event condition transmission unit of the server transmits the new event condition to the drive recorder.

2. The image recording system according to claim 1,
wherein the event condition generation unit generates the new event condition based on a feature of an image showing a dangerous driving situation having a high similarity to a feature of the continuously recorded image transmitted from the drive recorder.

3. The image recording system according to claim 1,
wherein the event condition generation unit generates the new event condition that includes a threshold value determined by a similarity between a feature of an image showing a dangerous driving situation and a feature of the continuously recorded image transmitted from the drive recorder.

4. The image recording system according to claim 1,
wherein the event condition generation unit generates the new event condition based on a feature of an image showing a safe driving situation greatly different from a feature of the continuously recorded video transmitted from the drive recorder.

5. The image recording system according to claim 1,
wherein the event condition generation unit generates the new event condition that includes a threshold value determined by a difference between a feature of an image showing a safe driving situation and a feature of the continuously recorded image transmitted from the drive recorder.
